(19) United States
(12) Patent Application Publication
(10) Pub. No.: US 2011/0244088 A1
(43) Pub. Date: Oct. 6, 2011

(54) Multi-Color Crackers and Method for Making Same

(75) Inventor: Eugenio Bortone, McKinney, TX (US)

(73) Assignee: FRITO-LAY NORTH AMERICA, INC., Plano, TX (US)

(21) Appl. No.: 12/753,538

(22) Filed: Apr. 2, 2010

(51) Int. Cl. A21D 13/04; A21D 6/00

(52) U.S. Cl. 426/249; 426/502; 426/560

(57) ABSTRACT

A method to produce a multi-characteristic dough sheet and the resultant food piece having distinct characteristic zones. In accordance with one embodiment of the present invention, the dough sheeting system involves sheeting a first dough component, extruding into pellets a second dough component, sprinkling the pellets onto the sheeted first dough component, and combining the two dough components in a second sheeting step. The resultant composite dough sheet maintains distinct dough component zones. This resultant dough sheet is then cut into individual food pieces, which are further processed to produce a unique edible snack, such as a marbled cracker or multi-color chip or crisp.

### BACKGROUND

1. Technical Field

The present invention relates to a method for processing dough to form a multi-color food piece, such as a marbled cracker. More specifically, this invention relates to a method for combining doughs of different colors and, potentially, other different characteristics in order to produce a finished food piece having distinctive zones.

2. Description of Related Art

Crackers and chips (or crisps) made from fabricated doughs, as opposed to slices of raw vegetables or fruits, are typically produced using a process called sheeting, wherein a dough is compressed between sheeting rollers. This compression between opposed rollers produces a thin layer, or a sheet, of dough which can then be cut into pieces and cooked. This sheeting process is used in the production of, for example, wheat-based crackers, tortilla chips, fabricated potato chips, fabricated vegetable chips, fabricated fruit chips, and other food pieces having as a starting material some type of dough.

In a dough sheeting operation, there are many variables that can affect the rheology, uniformity, consistency, composition and dimensions of sheeted dough and of comestible product derived therefrom. The consistency of dough sheet characteristics depends upon several process conditions including, but not limited to, ingredient selection, relative amount of each ingredient, uniformity of ingredient concentration, moisture content, sheeter roller gap size (nip size), height of dough on sheeter rollers (nip dough height), energy absorbed by the sheeted dough (work input), and speed of sheeting rollers. One or more pairs of sheeting rollers may be used to produce a dough sheet. Each roller of each pair of rollers may turn at an independent speed.

FIG. 1 is a schematic side view of prior art sheeting operations. A dough 106 is fed between a press roller 104 and a sheeter roller 102. The press roller 104 turns at a slightly slower rotational speed than the sheeter roller 102. This results in the dough after compression between the two rollers 102, 104, adhering to the sheeter roller 102. In the event that the dough is of such reology that it continues to stick to the sheeter roller 102, a means for removing the dough from the sheeter roller 102, such as a sheeter wire 108, mechanical scrapers, vibrating horns, or other devices known in the art can be used to remove the dough from the roller 102. The results is a sheet 110 of dough being deposited on a conveyor 118.

After the initial sheeting shown in FIG. 1, the dough sheet 110, depending on the specific application, may proceed to a second or third set of sheeting rollers (not shown) for further compression, thus producing a thinner and thinner sheet 110. At some point in the process, the dough is typically subjected to a cutting step, usually involving a cutting roller (not shown) in association with a sheeter roller 102. This may be done immediately after the initial compression between a first set of rollers 102, 104 and before depositing the sheeted dough 110 on the conveyor 118. After the sheet 110 is cut, the resultant dough pieces are further processed by, for example, cooking and seasoning.

Food pieces produced by the method described above are typically uniform in color, texture, and appearance. It may be desirable to produce a food piece having two or more distinct colors. It may be further desirable to produce a food piece that consists of at least two distinct dough starting materials that maintain their distinction after a sheeting operation, thereby producing different zones in the finished food piece. These distinctive doughs may contrast in color, moisture content, raw materials, viscosity, and average dough particle size, for example.

Such a multi-zone product is not possible to produce using the prior art technique shown in FIG. 1. If doughs having distinct colors and other characteristics are pre-blended prior to the sheeting operation, the sheeting step typically causes the doughs to bleed into each other, thus producing a food piece lacking in the distinct separation of the two doughs. This occurs because the pressure on the dough, or the work input, exerted during sheeting is such that the doughs become more homogenous than desired for the end product. This is true even when the doughs maintain distinct separation in a pre-mix prior to sheeting.

Consequently, a need exists for a method to produce a dough that consists of two or more distinct dough components which maintain separate characteristics, such as colors, after combining the distinct dough components. Such a method would produce a multi-color finished product such as a marbled cracker. Ideally, such method should use existing sheeting or other technology and provide for a continuous process with production rates similar to standard sheeting lines.

### SUMMARY OF THE INVENTION

A dough sheeting method and resultant food piece is disclosed which combines two or more distinct dough components to produce a finished product that retains distinct dough zones, thus producing a multi-color food piece. The method comprises the steps of sheeting a first or base dough to a first thickness by way of one or more sheeting steps, adding a second dough to said first dough after the first dough is sheeted to the first thickness, and sheeting said first dough and said second dough to a second thickness. The addition of the second dough occurs after the first dough is subjected to one or more sheeting steps, so that the two dough components are not subjected to the work input required to sheet to a final thickness that can result in an unacceptable homogenous combination. In one embodiment, the second dough component is extruded into a pellet form prior to the addition of the second dough to the base dough. This can be accomplished, for example, by dropping the second dough component in a pellet form onto the top of a dough sheet consisting of the base dough component. This dough sheet and the added pellets are then subjected to a further sheeting step, thus imparting a lower pressure profile (or less work input) on the combined dough material than if they had been combined at the outset.

The first dough component and the second dough component used in Applicant's invention are dissimilar in at least one characteristic, such as color or base ingredients. As a result, the food piece formed by the at least two-step sheeting operation of Applicant's invention comprises distinct zones, each of said distinct zone consisting of a dough component having at least one characteristic in variance with at least one other dough component of food piece. Thus, one aspect of Applicant's invention is a method for making a multi-color food piece. This method comprises the steps of sheeting a first dough component of a first color to form an intermediate dough sheet and then adding a second dough component of a second color to said intermediate dough sheet. After the addition of this second dough component, the intermediate dough sheet and the second dough component are subjected to an additional sheeting step. The final dough sheet is cut into dough pieces and cooked to form a multi-colored food piece. This food piece can comprise any number of base ingredients, including rice, wheat, potato, corn, and other grains, legumes, vegetables, fruits, seeds, and nuts.

The end product of Applicant's second sheeting step is a single dough sheet consisting of distinct dough components. This sheet can be cut into dough pieces which are further processed by methods known in the art, such as cooking and seasoning. The end product is a food piece, such as a marbled cracker, that exhibits a distinctive multi-colored appearance. The method uses existing sheeting and other technology and can be run at throughput rates similar to standard sheeting operations.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a side schematic view of a prior art dough sheeting system; and

FIG. 2 is a perspective view of a dough sheeting system according to one embodiment of the present invention.

### DETAILED DESCRIPTION

While the invention is described below with respect to a preferred embodiment, other embodiments are possible. The concepts disclosed herein apply equally to systems for producing sheeted material including all types of dough. The production of marbled crackers is used as a preferred embodiment to illustrate the invention. Furthermore, the invention is not limited to use of any specific piece of equipment or processing step disclosed herein. Other similar or related devices or methods may be used in conformance with the spirit of the invention. Other process measurements, control methods, or control elements may be so substituted or combined and used with the present invention. In the illustrated embodiments, the various objects and layers are drawn at a scale suitable for illustration rather than at the scale of the actual material.

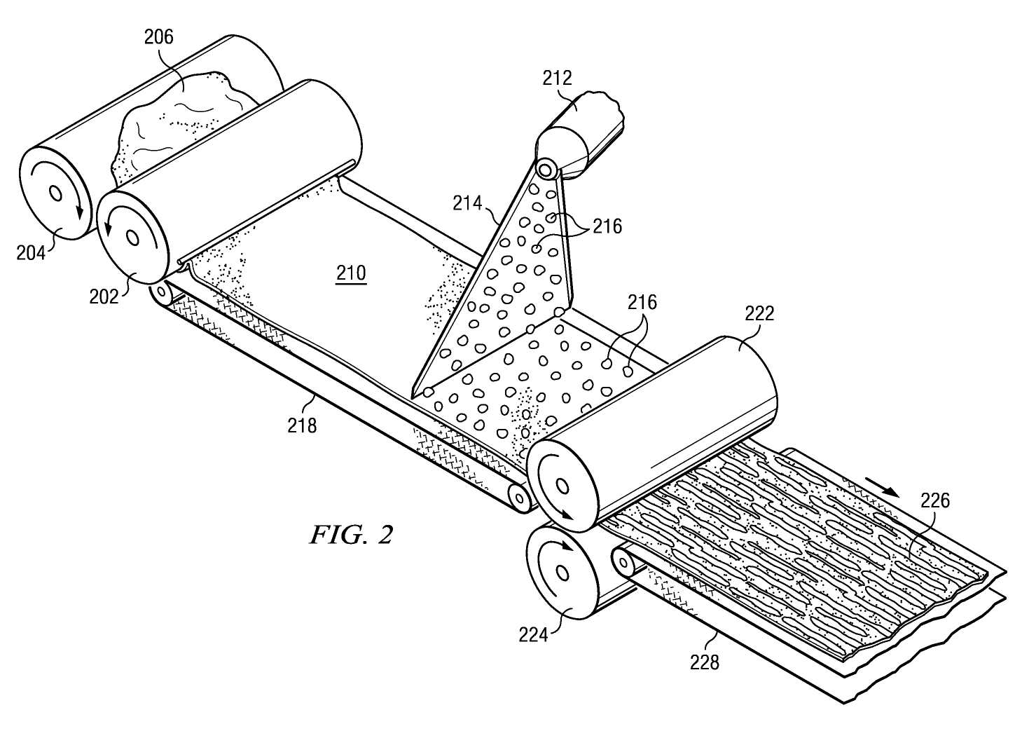

An embodiment of Applicant's invention is illustrated in FIG. 2. As with the prior art, a dough 206, which in Applicant's invention is referred to as a first dough component 206, is sheeted between two sheeting rollers 202, 204. This first sheeting step forms a dough sheet 210 or the intermediate dough sheet 210. A second dough component 216 is then added to the dough sheet 210. This dough sheet 210, with the added second dough component 216, proceeds along a conveyor 218 to a second set of sheeter rollers 222, 224. The second dough component 216 and intermediate dough sheet 210, which consists of the first dough component 206, are then subjected to a second sheeting step, thus producing a multi-characteristic dough sheet 226 or final dough sheet 226. Thus, Applicant's invention, in the embodiment illustrated, produces both an intermediate dough sheet 210 consisting of the first dough component 206 and a final dough sheet 226 consisting of both the first dough component 206 and the second dough component 216. This final dough sheet 226 is then cut and further processed by, for example, proceeding down one or more further conveyors 228 through a baking oven. Further processing can also consist of other means known in the art for forming a food piece, such as frying, microwaving, infrared radiation, vacuum dehydration, and combinations thereof.

In a preferred embodiment, the second dough component 216 is formed into pellets prior to addition to the intermediate dough sheet 210. These pellets, in a preferred embodiment, are formed by an extruder 212. This extruded 212 can be of many different types known in the art, such as single screw or double screw extruders. The extruding step can take place under low, medium, or high shear, depending on the starting materials and the desired final characteristics of the pellets 216. In a preferred embodiment, the pellets 216 are distributed on the intermediate dough sheet 210 in a fashion to allow a random yet relatively uniform distribution of the pellets 216 onto the intermediate sheet 210. This is done by, for example, depositing the extruded pellets 216 onto a vibratory tray 214 or some other means of distributing the pellets 216 in such as manner, such as using a vibrating conveyor or other spreading device (not shown).

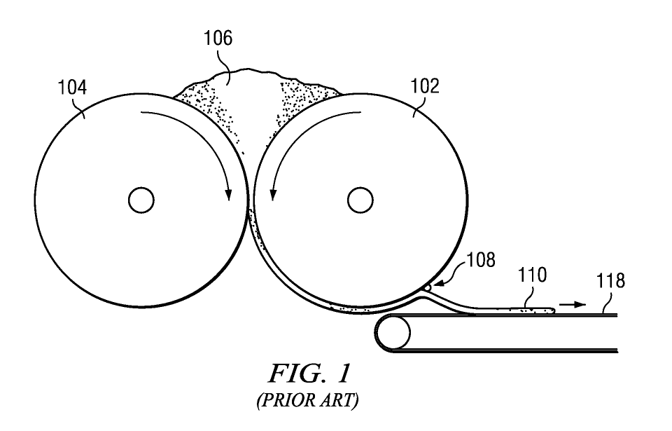

In order to maintain distinct zones of dough characteristics in the final dough sheet 226, Applicant uses a pressure profile or work input during the sheeting step following addition of the second dough component 216 to the intermediate dough sheet that is below the pressure profile or work input that would be experienced by a similar dough being sheeted to the same final thickness through one or more sheeting steps. Stated differently, the work input at the final sheeting step is lower than the work input of the alternative approach of mixing the two dough components prior to sheeting and then sheeting to the same final thickness. This lower pressure helps reduce the tendency of two distinct doughs becoming a more homogenous mixture. Thus, the first dough and the second dough component can have different base colors or other variances in characteristics. Using the prior art method described in FIG. 1, these two dough components under the pressure normally experienced during sheeting would bleed colors together such that the darker color would become the dominant color in the resultant dough sheet. This phenomena is avoided with Applicant's invention by adding the second dough component after the first sheeting step. Thus, the following sheeting step of Applicant's invention is performed at a pressure that is lower than the pressure of the combined sheeting steps of the prior art.

While Applicant's invention is illustrated in one embodiment using the addition of a second dough component 216 in a pellet form going through a second sheeting operation, it should be understood that other embodiments of Applicant's invention allow for variations on this theme. For example, the second dough component 216 can be added by means other than extrusion and the formation of a pellet. The second dough component 216 can consist of cut pieces of dough added to the intermediate dough sheet. More than two sheeting steps can be used as well. For example, the first dough component 206 can be sheeted to a target thickness through two or more sheeting steps before the second dough component 216 is added to the dough sheet 210. Also, more than one dough component can be added to the intermediate dough sheet 210. For example, two or more dough components can be added to the intermediate dough sheet 210 prior to the final sheeting step. In this embodiment, a final food piece is produced with multiple characteristic zones, such as multiple colors in a single cracker.

Table 1 below illustrates the starting ingredients for a food piece produced as one embodiment of Applicant's invention. Table 1 lists by dry weight percentage the ingredients of a first dough component 206 and a second dough component 216. Water in equal amounts was added to each of the dough components in order to obtain consistencies suitable for sheeting and extruding as described above. Once the two dough components are formed into a final dough sheet 226, the dough sheet was cut into square cracker shapes and baked and seasoned. The end product was a snack food piece having a marbled appearance. The colors represented in the marbling consisting of distinct dough zones that could be observed as distinct layers in a cross-section of the finished cracker.

TABLE 1

| | First Dough | Second Dough |
|---|---|---|
| Ingredient | Component | Component |
| Potato Flakes | 21.9% | 22.0% |
| Rice Flour | 21.9% | 22.0% |
| Rice Starch | 9.0% | 9.0% |
| Whole Oat Flour | 6.5% | 6.0% |
| Porphyra | 0.0% | 20.0% |
| Soy Isolate | 27.4% | 7.5% |
| Lentil Flour | 11.6% | 11.7% |
| Lecithin | 1.0% | 1.0% |
| Other Minor Ingredients | 0.7% | 0.8% |

More specifically with reference to Table 1, Applicant mixed the dry ingredients listed for the first dough component with water at ambient conditions until the resultant dough had a moisture content of 25% to 30% by weight. This first dough component was then sheeted in two sheeting steps to a thickness of about 1.5 mm to about 2 mm. The second dough component was formed by mixing the dry ingredients in the percent ratios listed in Table 1 with water at ambient conditions as well. This mixing step produced a second dough component having a moisture content by weight of 25% to 30% by weight. The second dough component was then put through a low-sheer, single screw extruder and formed into pellets having a bead shape with an approximately diameter of between about 1 mm to about 5 mm and a length of between about 2 mm to about 5 mm.

Because of the use of porphyra, a sea vegetable, as a component ingredient in the second dough component, the second dough component exhibits a dark green color characteristic. After extruding into pellet form, the second dough component is spread onto the intermediate dough sheet formed of the first dough component by way of a spreading conveyor. The intermediate dough sheet with the second dough component pellets sprinkled on top is then subjected to a final sheeting step. The final sheeting step involves a pressure profile that is lower than prior art sheeting required to sheet the same mixture to the same thickness when the dough components are mixed prior to sheeting. The pressure required is enough to produce a uniformly sheeted dough but not enough to cause the two dough components to become a homogenous mixture. The resultant final dough sheet is approximately 1.2 mm to 1.5 mm thick.

The final dough sheet 226 exhibits colors in streaks running in the direction of travel of the dough sheet, as can be seen in FIG. 2. This final dough sheet is then cut into squares. The square dough pieces are next baked to a moisture level of between 2% and 2.5% by weight and further seasoned. The resulting food piece in this particular embodiment is a cracker that is marbled in appearance. By breaking the cracker in two, distinct characteristic zones can be seen in the cracker, in this instance consisting of the different colored zones. The green colored dough of the second dough component can be seen as a separate layer that has maintained a boundary between the other dough component. This characteristic of the food pieces produced by Applicant's method allows for food pieces having separate zones of distinct characteristics different or other than color characteristics. For example, two distinct doughs can be combined such that a cracker will have zones with different final densities, blister characteristics, hardness, mouth feel, flavor, and other characteristics typical of a dough based food piece.

Other materials have been used to produce food pieces having multiple characteristics as described above. For example, crackers have been made using brown rice, white rice, and tapioca as primary ingredients, along with a sea vegetable for coloring. Applicant's invention is suitable for any number of doughs based on a wide range of starting ingredients, such as wheat, corn, potato, oats, sorghum, rice, millet, rye, barley, peas, chickpeas, lentils, pinto beans, kidney beans, broad beans, butter beans, runner beans, black eyed beans, almonds, peanuts, walnuts, pecans, brazil nuts, pumpkin seeds, sunflower seeds, sesame seeds, mustard seeds, fennel seeds, poppy seeds, squash seeds, carrots, parsnip, sweet potatoes, turnips, squash, courgette, asparagus, mushrooms, broccoli, cauliflower, sweet pepper, chili pepper, artichoke, celery, tomato, olives, aborigine, beetroot, fennel, onions, spinach, chard, cabbage, tapioca, and yucca. Thus, the specific embodiment disclosed in Table 1 is merely illustrative of the many different types of food pieces that are made by Applicant's invention.

While the invention has been particularly shown and described with reference to a preferred embodiment, it will be understood by those skilled in the art that various changes in form and detail may be made therein without departing from the spirit and scope of the invention.

I claim:

1. A method for producing a multi-characteristic, sheeted dough, said method comprising the steps of:
a) sheeting a first dough component to form a dough sheet;
b) adding a second dough component to said dough sheet, wherein said second dough component is dissimilar to said first dough component in at least one characteristic; and
c) sheeting said second dough component and said dough sheet, thus producing a multi-characteristic dough sheet.

2. The method of claim 1 wherein said second dough component is extruded into pellets prior to the addition step b).

3. The method of claim 1 wherein said first dough component comprises potato flakes and rice flour and said second dough component comprises porphyra.

4. The method of claim 1 further comprising the steps of:
d) cutting the dough sheet of step c) into dough pieces; and
e) cooking said dough pieces, thus producing food pieces.

5. A food piece produced by the method of claim 4.

6. The method of claim 1 wherein said dissimilar characteristic is color, thus producing a multi-colored dough sheet at step c).

7. A method for making a multi-color food piece, said method comprising the steps of:
a) sheeting a first dough component of a first color to form an intermediate dough sheet;
b) adding a second dough component of a second color to said intermediate dough sheet;
c) sheeting said second dough component and said intermediate dough sheet, thus producing a final dough sheet;
d) cutting said final dough sheet into dough pieces; and
e) cooking said dough pieces.

8. The method of claim 7 wherein said second dough component added at step b) consists of extruded pellets.

9. The method of claim 7 wherein the first dough component comprises potato and rice.

10. A food piece produced by the method of claim 7.

11. A food piece formed by sheeting and cutting, wherein said food piece comprises distinct zones, each of said distinct zones consisting of a dough component having at least one characteristic in variance with at least one other dough component of the food piece.

12. The food piece of claim 11 wherein said characteristic in variance is color.

13. The food piece of claim 11 wherein said food piece comprises rice.

14. The food piece of claim 11 wherein said food piece comprises wheat.

15. The food piece of claim 11 wherein said food piece comprises potato.

16. The food piece of claim 11 wherein said food piece comprises corn.
